(19) United States
(12) Patent Application Publication
(10) Pub. No.: US 2005/0123299 A1
(43) Pub. Date: Jun. 9, 2005

(54) Wavelength division multiplexing optical transmission system

(75) Inventors: Takashi Sakata, Kawasaki (JP); Kenichi Sasaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki-shi (JP)

(21) Appl. No.: 11/043,039

(22) Filed: Jan. 27, 2005

Related U.S. Application Data
(63) Continuation of application No. PCT/JP02/11376, filed on Oct. 31, 2002.

(51) Int. Cl. H04J 14/02

(52) U.S. Cl. 398/79

(57) ABSTRACT

A wavelength division multiplexing optical transmission system for multiplexing a plurality of optical signals of the wavelength different from each other. The system comprises a first converter converting the plurality of optical signals whose wavelengths are different from each other, into a plurality of electric signals, a generator generating check symbols for the plurality of electric signals input from the first converter, a second converter converting the check symbols input from the generator, into optical signals whose wavelengths are different from the plurality of optical signals, a multiplexer multiplexing and sending out the plurality of optical signals and the optical signals input from the second converter, and an isolator isolating the multiplexed optical signal input from the multiplexer.

### BACKGROUND OF THE INVENTION

The present invention relates to a technology that enables a long distance transmission at a low cost in a wavelength division multiplexing optical transmission system.

FIG. 7 shows a schematic system configuration of a conventional wavelength division multiplexing optical transmission system. TRP/RP is a transmission/reception transponder, MUX is an optical multiplexer, DMUX is an optical isolator, and OFA is an optical amplifier. In this conventional wavelength division multiplexing optical transmission system, a signal is converted into a narrow band optical wavelength signal by the transmission transponder TRP, wavelength division multiplexed (WDM) by the optical multiplexer MUX, and optically amplified by a transmission optical amplifier of the optical amplifier OFA, and then sent out to an optical transmission path. On the other hand, an optical signal attenuated in the optical transmission path is amplified by a reception optical amplifier of the optical amplifier OFA on the receiving side, isolated for each narrow band optical wavelength by the optical isolator DMUX, and converted into a wide band optical signal by the reception transponder RP, and then sent out to a client side apparatus. As kinds of transponders, a 2.4G transponder, a 600M transponder, a 1000BASE-LX transponder and a 1000BASE-SX transponder and the like are used.

In the above-mentioned system configuration, even if there is no optical amplifier OFA, it is possible to perform the transmission over a transmission distance of about 40 Km. However, this covers only 80% of a transmission block region in a metro area network. For this reason, in a case where the conventional wavelength division multiplexing optical transmission system is applied to the metro area network, the addition of the optical amplifier OFA capable of WDM transmission enables the transmission over a distance of about 80 Km at the maximum. Note that in the optical amplifier OFA, an erbium doped optical fiber amplifier (EDFA) to which erbium is added into an optical fiber and the like are used. In the EDFA, an excitation light from an excitation light source, such as a semiconductor laser, is let in the erbium doped optical fiber, thereby amplifying an input signal light propagating through the excited erbium doped optical fiber.

However, in the product for a metropolitan WDM and an access network, the economical efficiency is important, and an inexpensive product is basically required. In general, the cost of the wavelength division multiplexing optical transmission system has a high tendency depends on the price of the optical amplifier OFA.

Note that as such a conventional wavelength division multiplexing optical transmission system, various types have been proposed (for example, refer to Patent Document 1, Patent Document 2, and Patent Document 3).

[Patent Document 1]
JP 11-32008 A

[Patent Document 2]
JP 11-331132 A

[Patent Document 3]

### SUMMARY OF THE INVENTION

An object of the present invention is to enable a long distance transmission at a low cost in a wavelength division multiplexing optical transmission system.

In order to achieve the above object, the present invention provides a wavelength division multiplexing optical transmission system for multiplexing a plurality of optical signals whose wavelengths are different from each other, including: a first converter converting the plurality of optical signals whose wavelengths are different from each other, into a plurality of electric signals; a generator generating check symbols for the plurality of electric signals input from the first converter; a second converter converting the check symbols input from the generator, into optical signals whose wavelengths are different from the plurality of optical signals; a multiplexer multiplexing and sending out the plurality of optical signals and the optical signals input from the second converter; and an isolator isolating the multiplexed optical signal input from the multiplexer.

According to the present invention, check signals for a plurality of electric signals (transmission data) are generated by the generator and further multiplexed and sent out by the multiplexer. Thus, a receiving side (isolator side) allows check and self-correction of the transmission data in accordance with the check symbols. Hence, the transmission distance can be extended even without the amplifier OFA.

The wavelength division multiplexing optical transmission system further includes, for example: a third converter converting the optical signal converted by the second converter among the isolated optical signal input from the isolator, into the electric signal; a first extractor extracting the check symbol from the electric signal input from the third converter; a fourth converter converting the plurality of optical signals in the isolated optical signal input from the isolator, into a plurality of electric signals; a second extractor extracting a transmission data from the electric signals input from the fourth converter; and an error corrector carrying out an error correction of the transmission data extracted by the second extractor in accordance with the check symbol extracted by the first extractor.

The employment of the above-mentioned structures enables the transmission distance to be extended even without the amplifier OFA.

Further, in the wavelength division multiplexing optical transmission system, for example, the check symbol is generated by using a check symbol generation polynomial (for example, a polynomial for generating an error check correction code such as a Hamming code).

Further, in the wavelength division multiplexing optical transmission system, for example, the check symbol generation polynomial can be changed.

Further, in the wavelength division multiplexing optical transmission system, for example, the check symbol is included in a frame and transmitted.

Further, in the wavelength division multiplexing optical transmission system, for example, the frame including the check symbol is burst-multiplexed.

The employment of the above-mentioned structures enables higher transmission efficiency.

### BRIEF DESCRIPTION OF THE DRAWINGS

FIG. 1 is a diagram explaining a schematic system configuration of a wavelength division multiplexing optical transmission system according to an embodiment of the present invention.

FIG. 2 is a view explaining the schematic system configuration of the wavelength division multiplexing optical transmission system according to the embodiment of the present invention.

FIG. 3 is a view explaining the schematic system configuration of the wavelength division multiplexing optical transmission system according to the embodiment of the present invention.

FIG. 4 is a view showing a data processing image in the wavelength division multiplexing optical transmission system according to the embodiment of the present invention.

FIG. 5 is a view explaining a data array.

FIG. 6 is a view showing a wavelength arrangement image in the wavelength division multiplexing optical transmission system according to this embodiment.

FIG. 7 is a view explaining a schematic system configuration of a conventional wavelength division multiplexing optical transmission system.

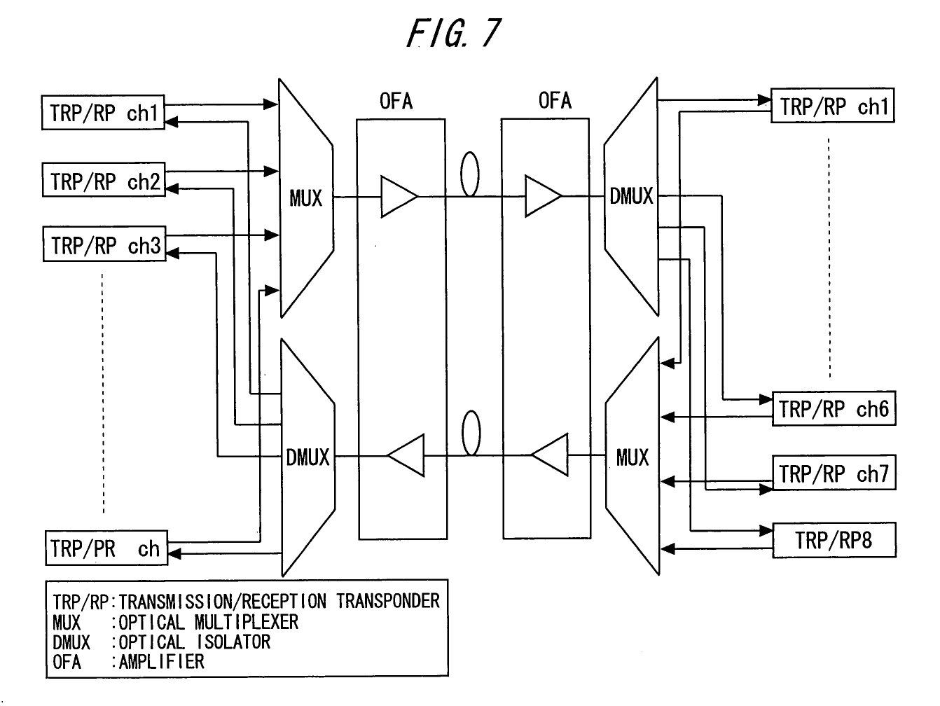

### DETAILED DESCRIPTION OF THE PREFERRED EMBODIMENT

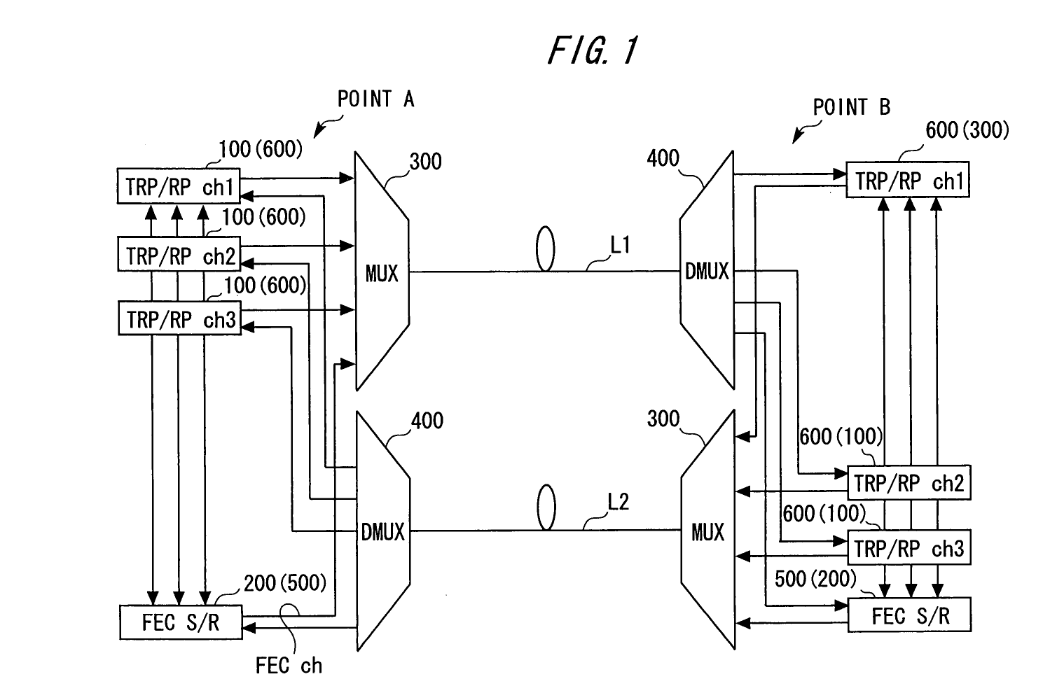

A wavelength division multiplexing optical transmission system according to an embodiment of the present invention will be described below with reference to the drawings. FIG. 1 is a diagram explaining the schematic system configuration of the wavelength division multiplexing optical transmission system according to the embodiment of the present invention.

The wavelength division multiplexing optical transmission system includes a plurality of transmission transponders 100, an FECS 200, a multiplexer 300, an isolator 400, an FECR 500 and a plurality of reception transponders 600, for each of points (for example, a point A and a point B).

The multiplexer 300 of a certain point (for example, the point A) and the isolator 400 of another point (for example, the point B) are connected through an optical transmission path L1 (refer to the upper stage of FIG. 1). Similarly, the isolator 400 of the certain point (for example, the point A) and the multiplexer 300 of the other point (for example, the point B) are connected through an optical transmission path L2 (refer to the lower stage of FIG. 1).

The configuration of the wavelength division multiplexing optical transmission system in this embodiment will be described below by paying attention to the multiplexer 300 of the point A and the isolator 400 of the point B (the same holds true as well by paying attention to the isolator 400 of the point A and the multiplexer 300 of the point B).

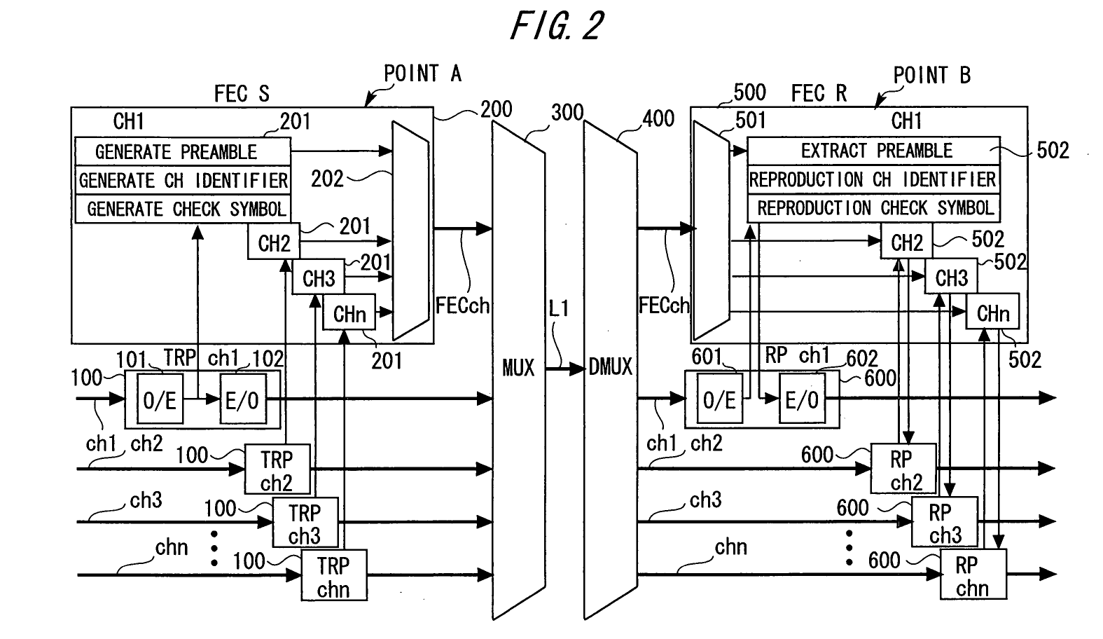

As shown in FIG. 2, a plurality of optical channels ch1 to chn are connected to the plurality of transmission transponders 100 (a first converter). The plurality of transmission transponders 100 are used to convert a plurality of optical signals of wavelengths λ1 to λn, which are input from their optical channels ch1 to chn and different from each other, into a plurality of electric signals. The optical channels ch1 to chn are the channels for transmitting the plurality of optical signals of the wavelengths λ1 to λn different from each other. Each of the transmission transponders 100 has a converter (O/E) 101 for converting the optical signal input from its corresponding optical channel into the electric signal and a converter (E/O) 102 for re-converting the electrical signal after the conversion into the optical signal.

The FECS 200 has a plurality of check symbol generators 201 and a multiplexer 202 (a second converter). The plurality of transmission transponders 100 (converters (O/E) 101) are connected to the plurality of check symbol generators 201. Each check symbol generator 201 is used to generate a check symbol (an FEC frame including the check symbol) to the electric signal (the transmission data included in a transmission data frame) input from the corresponding transmission transponder 100 (the converter (O/E) 101). Note that the transmission data is also referred to as an information symbol.

The plurality of check symbol generators 201 (generators) are parallel-connected to the multiplexer 202. The multiplexer 202 is used to burst-multiplex the FEC frame input from its check symbol generator 201 and also convert it into an optical signal of a wavelength λ0 different from the plurality of optical signals (the optical signals transmitted through the optical channels ch1 to chn).

An optical channel FECch and the plurality of optical channels ch1 to chn are parallel-connected to the multiplexer 300. The multiplexer 300 is used to multiplex and send out the plurality of optical signals of the wavelengths λ0 to λn, which are input from their optical channels FECch and ch1 to chn and different from each other.

The multiplexer 300 is connected through the optical transmission path L1, such as an optical fiber cable, to the isolator 400. The isolator 400 is used to isolate the multiplexed optical signal input from the multiplexer 300.

The FECR 500 has an isolator 501 (a third converter), a plurality of check symbol extractors 502 (a first extractor), and a memory for an FEC frame of an FIFO system (not shown).

The isolator 400 is connected through the optical channel FECch to the isolator 501. The isolator 501 is used to isolate the optical signal, which is burst-multiplexed by the multiplexer 202 in the isolated optical signals input from the isolator 400, and also convert the signal into the electric signal.

The isolator 501 is connected to the memory for the FEC frame. The electric signals (FEC frame) input from the isolator 501 are classified for each ch identifier and stored in the memory for the FEC frame.

The memory for the FEC frame is connected to the plurality of check symbol extractors 502. Each check symbol extractor 502 is used to extract the check symbol from the FEC frame read out from the memory for the FEC frame.

The isolator 400 is connected through the plurality of optical channels ch1 to chn to a plurality of reception transponders 600 (a fourth converter). The plurality of reception transponders 600 are used to convert a plurality of optical signals (optical signals transmitted through the optical channels ch1 to chn) among the isolated optical signals input from the isolator 400, into a plurality of electric signals. Each reception transponder 600 has a converter (O/E) 601 for converting the optical signal input from the corresponding optical channel into the electric signal and a converter (E/O) 602 for re-converting the electric signal into the optical signal.

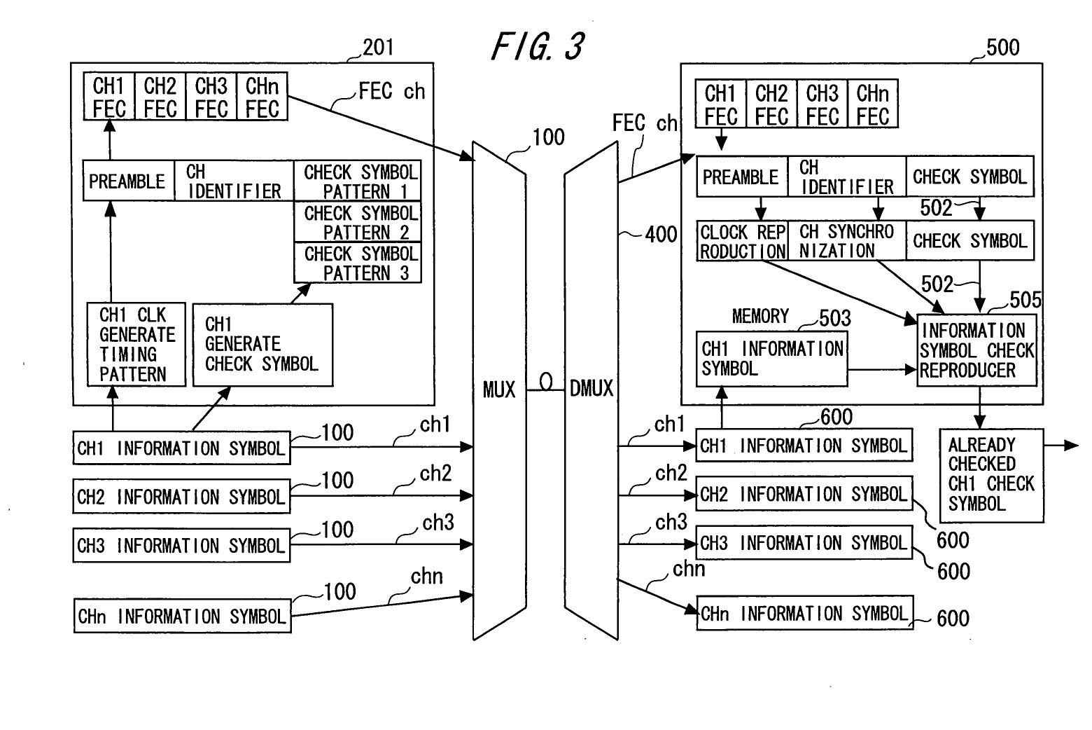

As shown in FIG. 3, the FECR 500 further has a memory 503 for a transmission data frame of the FIFO system, a plurality of transmission data extractors (a second extractor) 504 and an information symbol check reproducer 505. Here, FIG. 3 shows one of the plurality of transmission data extractors 504.

The plurality of reception transponders 600 (converters (O/E) 601) are connected to the memory 503 for the transmission data frame. The electric signals (transmission data frames) input from the plurality of reception transponders 600 are classified for each ch identifier and stored in the memory 503 for the transmission data frame.

The memory 503 for the transmission data frame is connected to the transmission data extractor 504. The transmission data extractor 504 is used to extract transmission data from the transmission data frame read out from the memory 503 for the transmission data frame.

The check symbol extractor 502 and the transmission data extractor 504 are connected to the information symbol check reproducer (error corrector) 505. The information symbol check reproducer 505 is used to carry out the error check and error correction of the extracted transmission data, which is input from the transmission data extractor 504, in accordance with the extracted check symbol that is input from the check symbol extractor 502.

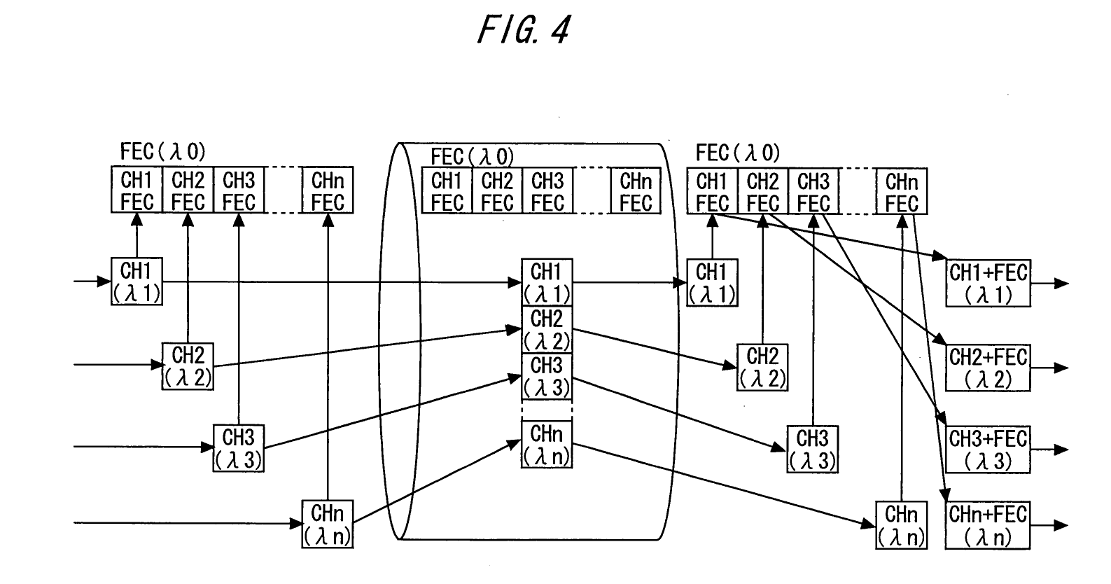

The operations of the wavelength division multiplexing optical transmission system having the above-mentioned configuration will be described below with reference to FIG. 2 to FIG. 4.

In each transmission transponder 100, the plurality of optical signals (the transmission data frames including the transmission data) of wavelengths λ1 to λn, which are input from the corresponding optical channels ch1 to chn and different from each other, are converted into the electric signals by the converter (O/E) 101 and sent out to the FECS 200. At the same time, in each transmission transponder 100, its electric signal is re-converted into the optical signal by the converter (E/O) 102 and sent out to the optical multiplexer 300.

In the FECS 200, the plurality of check symbol generators 201 generate the check symbols (the check symbol frames including the check symbols) to the plurality of electric signals (the transmission data included in the transmission data frames) input from the respective transmission transponders 100. More specifically, the symbols are generated as follows. For example, the check symbol generator 201 extracts a frame pulse (a CLK timing pattern of the ch1) from a portion corresponding to a header of the electric signal (the transmission data frame) input from the transmission transponder 100 corresponding to the optical channel ch1 (ch1 CLK timing pattern generation). Also, the check symbol generator 201 generates the check symbol (also referred to as a check symbol pattern or an error check correction code) by using a predetermined check symbol generation polynomial (for example, a polynomial for generating an error check correction code such as a Hamming code) (ch1 check symbol generation). Note that, in this embodiment, the check symbol generation polynomial is held in the memory or the like of the FECS 200, and the polynomial can be changed from a predetermined terminal or the like by a user.

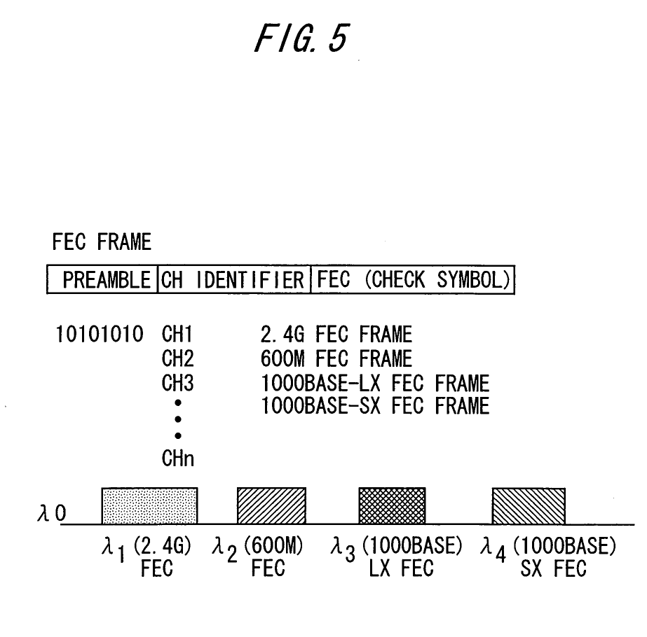

The check symbol generator 201 generates the FEC frame, in which the extracted frame pulse is arranged in a preamble section, the ch identifier to identify the optical channel ch1 is arranged in a ch identifier unit (the numbering of the frame), and the generated check symbol is arranged in a check symbol pattern unit, respectively (refer to FIG. 5), and sent out to the multiplexer 202. The same applies to the optical channels ch2 to chn other than the optical channel ch1.

The multiplexer 202 burst-multiplexes the FEC frame parallel-input from the plurality of check symbol generators 201, and also converts it into the optical signal of the wavelength λ0 different from the plurality of optical signals (the optical signals transmitted through the optical channels ch1 to chn), and then sends out the signal through the optical channel FECch to the multiplexer 300. Note that, the FEC frame is sent out at a speed corresponding to a data speed of each channel (refer to FIG. 5).

The multiplexer 300 multiplexes the plurality of optical signals of the wavelengths λ0 to λn, which are parallel-input from the plurality of optical channels (the optical channel FECch and the optical channels ch1 to chn) and different from each other, and sends out the signals to the isolator 400.

The isolator 400 isolates the multiplexed optical signal input from the multiplexer 300 and sends out the signal to the FECR 500 and the plurality of reception transponders 600.

Among the isolated optical signals input from the isolator 400, the optical signal burst-multiplexed by the multiplexer 202 is isolated by the isolator 501 of the FECR 500 and converted into the electric signal. The electric signals (FEC frame) after the conversion are classified for each ch identifier and stored in the memory (not shown) for the FEC frame of the FECR 500.

In the respective reception transponders 600, the optical signals input from the corresponding one of the optical channels ch1 to chn are converted into the electric signals by the converter (O/E) 601 and sent out to the FECR 500.

The electric signals (the transmission data frame) input from each reception transponder 600 are classified for each ch identifier and stored in the memory 503 for the transmission data frame of the FECR 500.

In the FECR 500, the plurality of check symbol extractors 502 and the plurality of transmission data extractors 504 extract the check symbols and the transmission data (in addition, preamble and the ch identifier), respectively, from the FEC frames and transmission data frames, which are read out from the memory for the check symbol frame (not shown) and the memory 503 for the transmission data frame.

In the FECR 500, the information symbol check reproducer 505 carries out error check of the transmission data input from the transmission data extractor 504 in accordance with the check symbol input from each check symbol extractor 502, and if an error exists in check target transmission data, carries out an error correction of the check target transmission data (self-check correction). That is, the FECR 500 carries out clock reproduction for each optical channel by means of the preamble extraction, and assigns the frame to each optical channel ch based on the ch identifier, and also collates the check symbol with the information symbol, and then carries out an error correction process.

The information symbol check reproducer 505 sends out the transmission data frame whose error is corrected (if the error does not exist, its original transmission data frame on which the error-correction is not performed) to the reception transponder 600 corresponding to the ch identifier. Note that, the correcting process (reproducing process) performed by the information symbol check reproducer 505 is executed in accordance with the clock generated from the preamble.

In the reception transponder 600, the transmission data frame which is input from the FECR 500 and whose error is corrected (or if the error does not exist, its original transmission data frame on which the error-correction is not performed) is converted into the optical signal by the converter 602 (E/O) and sent out to the corresponding optical channel. The same applies to the optical channels ch2 to chn other than the optical channel ch1.

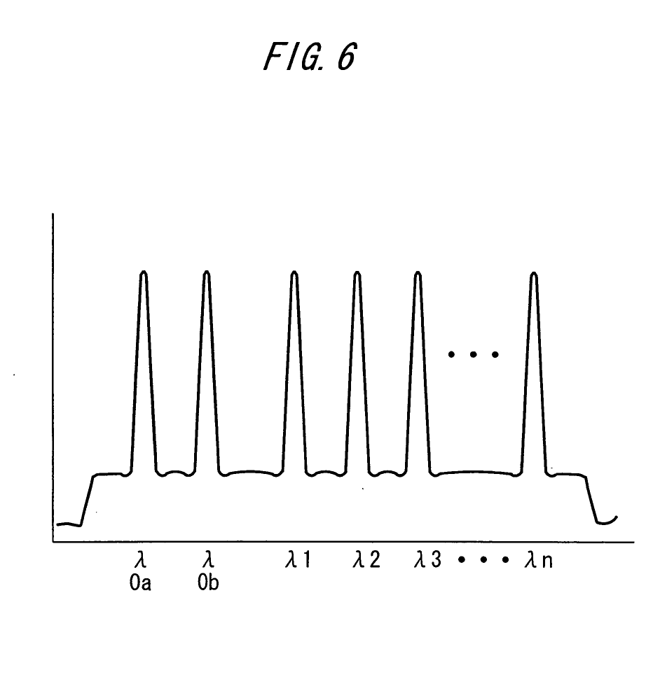

FIG. 6 is a view showing the wavelength arrangement image in the wavelength division multiplexing optical transmission system in this embodiment. In this way, as the FEC wavelength λ0, a plurality of wavelengths λ0a, λ0b are defined, which consequently enables the protection configuration.

As explained above, the wavelength division multiplexing optical transmission system in this embodiment generates the FEC frames including the check symbols for the information symbols (frame units) input from the plurality of transmission transponders 300 corresponding to the respective optical channels ch1 to chn, and collectively transmits the frames as one wave. The error correction is performed on the information symbols (frame units) input from the reception transponders 600 corresponding to the respective optical channels ch1 to chn, on the receiving side, on the basis of the check symbols included in the FEC frame. Due to this error correction process, a system gain can be obtained, thereby extending the transmission distance. Also, in the wavelength division multiplexing optical transmission system according to this embodiment, the error correction code can be suitably selected, thereby extending all of the wavelengths collectively by the extended distance.

Note that, when the transmission transponder 100 (the reception transponder 600) is the 2.4G transponder, the application of an error correction code RS (255. 239) attains the improvement of a system gain of 4 to 5 dB. When a system design is carried out under the assumption that an optical fiber loss of a typical optical transmission path is 0.35 dB/km, it can be extended by 11 to 14 km, and the transmission over a distance of 55 km at the maximum becomes possible in the system having no OFA. The error correction code RS (255. 239) is a 256-ary cyclic code in which a code length is 255, an information symbol number is 239, and a check symbol is 16.

The present invention can be embodied in other various modes without departing from the technical idea or main feature of the present invention. Thus, the above-mentioned embodiment is only given by way of example. The present invention should not be construed exclusively as being limited by the description of the embodiment.

### INDUSTRIAL APPLICABILITY

According to the present invention, the transmission distance can be extended without the amplifier OFA, in the wavelength division multiplexing optical transmission system.

1. A wavelength division multiplexing optical transmission system for multiplexing a plurality of optical signals whose wavelengths are different from each other, comprising:
a first converter converting the plurality of optical signals whose wavelengths are different from each other, into a plurality of electric signals;
a generator generating check symbols for the plurality of electric signals input from the first converter;
a second converter converting the check symbols input from the generator, into optical signals whose wavelengths are different from the plurality of optical signals;
a multiplexer multiplexing and sending out the plurality of optical signals and the optical signals input from the second converter; and
an isolator isolating the multiplexed optical signal input from the multiplexer.

2. The wavelength division multiplexing optical transmission system according to claim 1, further comprising:
a third converter converting the optical signal converted by the second converter among the isolated optical signals input from the isolator, into an electric signal;
a first extract or extracting the check symbol from the electric signal input from the third converter;
a fourth converter converting the plurality of optical signals among the isolated optical signals input from the isolator, into a plurality of electric signals;
a second extractor extracting a transmission data from the electric signals input from the fourth converter; and
an error corrector carrying out an error correction of the transmission data extracted by the second extractor in accordance with the check symbol extracted by the first extractor.

3. The wavelength division multiplexing optical transmission system according to claim 1, wherein the check symbol is generated by using a check symbol generation polynomial.

4. The wavelength division multiplexing optical transmission system according to claim 3, wherein the check symbol generation polynomial can be changed.

5. The wavelength division multiplexing optical transmission system according to claim 1, wherein the check symbol is included in a frame and transmitted.

6. The wavelength division multiplexing optical transmission system according to claim 4, wherein the frame including the check symbol is burst-multiplexed.
